(19) United States
(12) Patent Application Publication
(10) Pub. No.: US 2021/0221344 A1
(43) Pub. Date: Jul. 22, 2021

(54) OPEN-LOOP CONTROL UNIT, AXLE MODULATOR AND BRAKING SYSTEM

(71) Applicant: WABCO Europe BVBA, Brussels (BE)

(72) Inventor: Arne MICHAELSEN, Seelze (DE)

(21) Appl. No.: 16/306,184

(22) PCT Filed: Apr. 3, 2017
(86) PCT No.: PCT/EP2017/000407

§ 371 Date: Nov. 30, 2018

(30) Foreign Application Priority Data
Jun. 2, 2016 (DE) 10 2016 006 763.2

(51) Int. Cl. B60T 8/32; F16D 66/02; B60T 17/22

(52) U.S. Cl. CPC B60T 8/329; F16D 66/021; B60T 8/1766; B60T 2240/00; B60T 17/221

(57) ABSTRACT

Disclosed is an axle modulator for regulation of the brake cylinder pressure on one or both sides of at least one axle of a vehicle, for example a vehicle with a pneumatic brake system. Revolution rate sensors and brake lining wear sensors can be connected for readout. The axle modulator is provided with separate connections for active and passive revolution rate sensors. Also disclosed is a regulating unit for an axle modulator. Further disclosed is a braking system with at least one brake control unit and with at least one regulating unit and/or an axle modulator.

### CROSS-REFERENCE TO RELATED APPLICATIONS

This application is a national phase entry of PCT/EP2017/000407, filed Apr. 3, 2017, which claims priority to German Patent Application No. 10 2016 006 76302, filed Jun. 2, 2016, both of which are incorporated herein by reference in their entirety.

### FIELD OF THE INVENTION

The invention relates to an axle modulator, a control unit for the axle modulator, a braking system with at least one brake control unit and the axle modulator, and a vehicle including the braking system.

### BACKGROUND OF THE INVENTION

Electronic braking systems (EBS) for vehicles are manufactured in different versions. In particular, for use in heavy vehicles, such as trucks, buses and similar, pneumatic braking systems are typically used. For actuating the individual brake cylinders on the wheels, so-called axle modulators (A×M) are typically provided. The axle modulators are used to control the brake cylinder pressure on both sides in the form of the respective wheels of an axle or a plurality of axles. For this purpose, the axle modulator for an axle typically comprises two pneumatically independent pressure control circuits, each with a ventilation and venting valve, each with a brake pressure sensor and common control electronics in the form of a regulating unit.

The axle modulator detects the revolution rates of the wheels by means of revolution rate sensors, in particular wheel revolution rate sensors, analyses the rates and sends them to a brake control unit in the form of a central module, which thereupon determines the setpoint pressures. However, the calculation can optionally also be carried out by the regulating unit of the axle modulator. In this case, different versions of the revolution rate sensors exist with passive types of sensor on the one hand and active types of sensor on the other hand. Such versions require different actuation and analysis.

As a rule, the axle modulator carries out at least control of the anti-lock brake system (ABS) automatically by, for example, modifying the specified setpoint pressure in the event of a tendency to locking or spinning of at least one wheel. For this purpose, the described detection of the wheel revolution rates is necessary.

Besides the revolution rate sensors, brake lining wear sensors for detection of the condition of the brake linings are also typically provided. The sensors can be embodied both as threshold value sensors for detection of maximum wear or for the continuous detection of the condition of the brake linings.

For carrying out the regulation tasks, the axle modulator comprises the aforementioned regulating unit. This regulating unit in particular carries out the described detection of measurement values and the regulation tasks.

A disadvantage of known regulating units or axle modulators is that, depending on the revolution rate sensor used, different axle modulators or regulating units for axle modulators must be used. This is because the actuation and analysis are carried out passively on the one hand and there are active revolution rate sensors acting in a different way on the other hand. Therefore, in the prior art different versions of the axle modulator or the regulating unit must be provided by the manufacturer of the braking systems for this purpose, which can actuate and read out active sensors on the one hand and passive sensors on the other hand. Alternatively, a choice of the sensors and hence the associated axle modulator or the control unit is also required by the vehicle manufacturer at an early stage in the production process of a vehicle. This results in high warehousing and planning costs at multiple places.

### SUMMARY OF THE INVENTION

Embodiments of the present invention provide an axle modulator or a regulating unit for an axle modulator that eliminates the described disadvantages. In particular, an axle modulator of this type or a regulating unit of this type for the axle modulator is suitable for handling both active and passive revolution rate sensors in one unit.

Accordingly, in one embodiment, an axle modulator is provided with separate connections for active revolution rate sensors on the one hand and passive revolution rate sensors on the other hand. Thus, the special features of the two types of revolution rate sensor can be accounted for when reading out and analyzing. An active revolution rate sensor can accordingly connect to one connection, whereas a passive revolution rate sensor can connect to another connection. Thus, both active and passive revolution rate sensors can be connected to the axle modulator. An axle modulator of this type can be embodied for regulation of the brake pressure on one or both sides of an axle. Accordingly, separate connections can be provided for two active revolution rate sensors on the one hand and two passive revolution rate sensors on the other hand. In this case, a connection for both an active revolution rate sensor and a passive revolution rate sensor is typically provided on each side. Thus, both sides or wheels of an axle can be served at the same time by the axle modulator.

In certain embodiments, two separate connections are provided for one side or for each side of the at least one axle. Thus, a plurality of sensors can connect on each side of the axle. Identical connections can be provided for both sides of the axle.

In accordance with one embodiment, two connections per side of the axle are provided for each axle. In particular, in this case one connection is embodied for passive revolution rate sensors and another connection is embodied for active revolution rate sensors. This means that two connections are associated with each side and hence each wheel of an axle. In this case, both a passive revolution rate sensor and an active revolution rate sensor can be provided per side of the axle.

In these and other embodiments, active and passive revolution rate sensors can be connected alternatively to each other. This means that the axle modulator can read out and actuate either active or passive revolution rate sensors. The axle modulator can be configured to ignore the connection of a further revolution rate sensor to the second, free separate connection. Alternatively, priority control of either the passive or the active revolution rate sensor is possible. In this case, the respective subordinate revolution rate sensor can be ignored by the axle modulator or can only be activated in the event of a malfunction.

In certain embodiments, a brake lining wear sensor can be connected to at least some connections, optionally to each of the connections. The connection can be made instead of a revolution rate sensor. Accordingly, all connections for revolution rate sensors are initially also suitable for contacting at least one brake lining wear sensor. The axle modulator can thus operate and read out brake lining wear sensors both on a connection for active revolution rate sensors and on a connection for passive revolution rate sensors.

In these and other embodiments, each of the connections comprises two contacts, or two electrical conductors for the connection of a sensor. The sensor can be a revolution rate sensor or a brake lining wear sensor. This takes into account the usual two-wire connection for the sensors. Alternatively, however, other types of connection are possible, for example with a conductor and a return via other components of the vehicle, such as the body, or a contact with more than two conductors, optionally also by a bus system.

At least one active revolution rate sensor and at least one brake lining wear sensor can optionally be connected at the same time. Thus, reading out and analyzing both types of sensor on an axle modulator are enabled.

In one embodiment of the invention, two active revolution rate sensors and two brake lining wear sensors can be connected at the same time. The sensors are provided for the two sides of an axle, i.e. in particular for two mutually independently rotatable wheels. Thus, the wheel revolution rates and the condition of the brake linings can be analyzed at the same time, optionally for a plurality of wheels.

At least one passive revolution rate sensor and at least one brake lining wear sensor can optionally be connected at the same time. Thus, reading out and analyzing both types of sensor on an axle modulator are enabled.

In an alternative embodiment of the invention, two passive revolution rate sensors and two brake lining wear sensors can be connected at the same time. These sensors are provided for the two sides of an axle, i.e. in particular for two mutually independently rotatable wheels. In this case, the wheel revolution rates can be analyzed by the passive revolution rate sensors, and the condition of the brake linings can be determined at the same time.

At least one first connection and at least one second connection are generally provided for connecting sensors for one side of the axle. Thus, parallel reading out and parallel analysis of a plurality of sensors on one side of the axle are enabled.

In these and other embodiments, an active revolution rate sensor can be connected to the at least one first connection and a brake lining wear sensor can be connected to the at least one second connection. Alternatively, a brake lining wear sensor can be connected to the at least one first connection and a passive revolution rate sensor can be connected to the second connection. Thus, either active or passive revolution rate sensors can be used in combination with brake lining wear sensors.

In certain embodiments, at least two first connections and two second connections are provided for the connection of sensors, in particular revolution rate sensors and/or brake lining wear sensors. The first and second connections are used for a corresponding association and targeted connection of the active and passive revolution rate sensors.

Two active revolution rate sensors can optionally be connected to the first connections and two brake lining wear sensors can optionally be connected to the second connections. Alternatively, two brake lining wear sensors can be connected to the first connections and two passive revolution rate sensors can be connected to the second connections. This means that an association of the passive and active revolution rate sensors with the specific connections to the control unit or to the axle modulator is carried out. The brake lining wear sensors can be connected to a respective dedicated connection on each side. Thus, it is not necessary to differentiate between active and passive revolution rate sensors at a single connection on the sides of the control unit. Moreover, the incorrect choice of types of sensor can be prevented thereby, because only one of the types of sensor can be connected at each of the connections. Optionally, differently embodied plug connectors prevent the interchanging of passive and active sensors.

In accordance with a further embodiment, a regulating unit for an axle modulator implements the connections provided for the operation of the axle modulator and controls the corresponding valves, switches and the like. The axle modulator is then used directly for regulation of the brake cylinder pressures, as described above.

In accordance with yet another embodiment, a braking system comprises at least one brake control unit for control. Moreover, at least one regulating unit is provided, as described above. The regulating unit can be part of an axle modulator, as described above, or can be embodied as a separate regulating unit with suitable external components. The braking system is in particular a pneumatic braking system.

### BRIEF DESCRIPTION OF THE DRAWINGS

The invention is described in detail below with reference to the accompanying figures, in which:

FIG. 1 shows an axle modulator according to the invention with connected passive revolution rate sensors, and

FIG. 2 shows the axle modulator of FIG. 1 with connected active revolution rate sensors, and

FIG. 3 shows a section of an example of a circuit of an axle modulator according to the invention.

### DETAILED DESCRIPTION

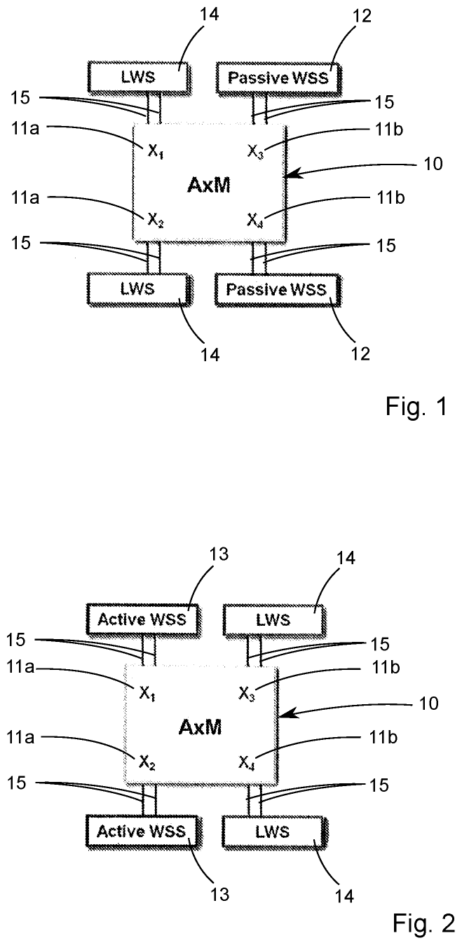

With reference to the specific embodiment of the figures, where like numerals generally indicate like parts throughout the several views, an axle modulator 10 according to an embodiment of the invention is shown in FIGS. 1 and 2 by way of example. FIG. 1 is a block diagram, in which only the components related to the embodiment of the invention shown are included.

Because an axle modulator of this type 10 is provided for regulation of the brake pressure of corresponding brake cylinders of an axle or a plurality of axles, the axle modulator 10 typically comprises corresponding valves or valve outputs for actuating with compressed air. Corresponding inputs for delivering the compressed air are also not shown here. The actual control or regulation of the axle modulator 10 is carried out by an integrated regulating unit. The regulating unit is an electronic control unit that is also not shown here, which carries out the analysis of the sensor data on the one hand and the calculation of the necessary brake pressures on the other hand. Moreover, the actual actuation of the valves for adjusting the brake pressure in the brake cylinders is also carried out.

Because the axle modulators 10 in question are units suitable for one or a plurality of axles, the connection of both the sensors and the corresponding valves is always carried out in pairs. Thus, it is ensured that both sides of an axle, i.e. accordingly the wheels on both sides of the axle, can be monitored by the corresponding sensors and on the other hand a corresponding brake pressure can be generated on both sides of the axles. The corresponding hydraulic braking systems are supplied with the delivered compressed air and ensure a regulated braking effect on the respective wheel.

Corresponding anti-slip, anti-locking or even anti-roll devices may also be implemented by the individual axle modulator 10. The actual control can be carried out by the control electronics or control unit or regulating unit integrated within the axle modulator 10. Alternatively, however, even external components can be provided for carrying out individual regulation or control tasks. For this purpose, The external components are to be suitably connected to the axle modulator 10.

The axle modulator 10 that is shown schematically here comprises a total of four connections 11a, 11b. The connections 11a and 11b are additionally denoted with the symbols X₁, X₂, X₃ and X₄ to enable distinction. The connections are used for connecting sensors to the axle modulator 10.

In this case, the two connections 11a, 11b denoted by X₁ and X₃ are provided for the connection of sensors on the one side of the axle, i.e. in particular of a first wheel. The two connections 11a, 11b denoted by X₂, and X₄ are provided for the connection of sensors on the other side of the axle, i.e. in particular of a second wheel.

In FIG. 1, the axle modulator 10 is accordingly provided with two passive revolution rate sensors 12. In contrast, the same axle modulator 10 in FIG. 2 is fitted with two active revolution rate sensors 13. The active or passive revolution rate sensors 12, 13 are typically wheel revolution rate sensors (Wheel Speed Sensor, WSS), which can detect the current rotation rate of the associated wheel. In this case, either actively measuring sensors or passively measuring sensors are conceivable as are also other versions.

In both cases of FIGS. 1 and 2, moreover, in each case two brake lining wear sensors 14 are connected to the axle modulator 10. The sensors are used to monitor the condition of the brake linings. This can be carried out point-by-point, i.e. selectively, or continuously. In particular, a defined maximum value can be analyzed or a continuous measurement can be carried out. This depends upon which measuring technique is used. Typically, in doing so a maximum value of the wear of the brake lining is detected, from which a corresponding report is provided to the axle modulator 10.

The connection of the passive revolution rate sensors 12 to the axle modulator 10 is carried out in the present embodiment of the invention at the connections 11b denoted by X₃ and X₄. Conversely, the active revolution rate sensors 13 of FIG. 2 are connected to the connections 11 a denoted by X₁ and X₂. This is why the axle modulator 10 comprises in each case two connections 11 a fitted for the connection of passive revolution rate sensors 12 and at the same time two further connections 11b embodied for the connection of active revolution rate sensors 13. In the exemplary embodiment shown, the passive revolution rate sensors 12 can be connected to the connections 11b denoted by X₃ and X₄. Active revolution rate sensors 13 are by contrast to be connected to the connections 11a denoted by X₁ and X₂ here.

Typically, only one pair of revolution rate sensors 12, 13 is necessary on an axle modulator 10 for measuring both sides of an axle. For this purpose, either passive revolution rate sensors 12 or active revolution rate sensors 13 are connected.

According to the present embodiment of the invention, all connections 11a, 11b of the axle modulator 10 are adapted to be fitted with brake lining wear sensors 14. Accordingly, sensors 14 of this type read out at all connections 11a, 11b.

Once a pair X₁ and X₂ or X₃ and X₄ of the connections 11a or 11b is already fitted with the associated type of revolution rate sensor, the respective free pair of connections X₃ and X₄ or X₁ and X₂ of the connections 11b or 11a is consequently fitted with brake lining wear sensors 14. Specifically, this means that in FIG. 1 the passive revolution rate sensors 12 are connected to the connections 11b denoted by X₃ and X₄. In this case, brake lining wear sensors 14 are connected to the two connections 11a denoted by X₁ and X₂.

Conversely, in FIG. 2, two active revolution rate sensors 13 are connected to the axle modulator 10 with the connections 11 a denoted by X₁ and X₂. Consequently, a respective brake lining wear sensor 14 is connected to the two free connections 11b denoted by X₃ and X₄.

For connecting the sensors 12, 13, 14, the connections 11a, 11b in the exemplary embodiment shown each comprise two electrical conductors 15. Accordingly, this is a two-wire system for connecting the corresponding sensors. The actuation and analysis of the sensors 12, 13, 14 can be carried out here both in an analog manner and in a digital manner. Nevertheless, typically an analog analysis is utilized. Likewise, in principle bus systems could also be used at this point. But because the axle modulator 10 carries out the specific analysis, direct actuation without separate addressing on a bus can be advantageous.

In principle, of course, other systems than two-wire systems are possible. Connecting the sensors 12, 13, 14 to the axle modulator 10 and a return via the body is also possible as well as a connection with more than two conductors 15.

As a result, a single type of axle modulator 10 is suitable for use in different installation situations. Specifically, warehousing costs and planning costs are reduced, because decisions about the choice of the specific types of sensor 12, 13, 14 or the axle modulator 10 only have to be made later in the process than when different types of axle modulator 10 must be provided for passive or active revolution rate sensors 12, 13 according to the prior art. The number of versions of axle modulators 10 to be kept is thus reduced according to the embodiment of the invention.

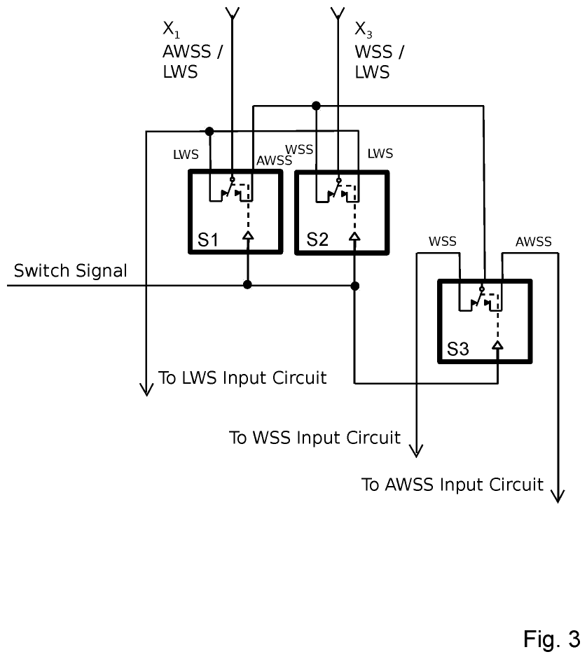

FIG. 3 shows a section of an example of a circuit for an axle modulator according to an embodiment of the invention.

In FIG. 3, the various types of sensors considered are designated. The brake lining wear sensors 14 are designated as an LWS (Linear Wear Sensor). Active revolution rate sensors 13 are designated as an AWSS (Active Wheel Speed Sensor) and passive revolution rate sensors 12 as a WSS (Wheel Speed Sensor).

Three changeover switches S1, S2 and S3 are provided. The connections X₁ and X₂ are connected to the switch contact of the first or second changeover switch S1, S2. In this case, the two respective free contacts are alternately connected either to the LWS input (“To LWS Input Circuit”) of the control unit or the switch contact of the third changeover switch S3. The third changeover switch S3 then switches alternately based on the switch signal between the input for passive revolution rate sensors WSS (“To WSS Input Circuit”) and for active revolution rate sensors AWSS (“To AWSS Input Circuit”).

A switch signal thus acts on the three changeover switches S1, S2, S3 at the same time.

A changeover of the connection X₁ on S1 between LWS and AWSS causes a changeover of the connection X₃ on S2 between WSS and LWS at the same time. Moreover, the inputs of the control unit are correspondingly changed over by S3 at the same time.

The switch signal for the changeover can, for example, be produced based on a plug contact as encoding for the sensors, by automatic detection of the types of sensor or even by manually changing a switch.

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

1-16. (canceled)

17. An axle modulator for regulation of brake cylinder pressure on at least one side of at least one axle of a vehicle, the axle modulator comprising:
a first connection configured to connect to an active revolution rate sensor or a brake lining wear sensor; and
a second connection configured to connect to a passive revolution rate sensor or a brake lining wear sensor;
wherein an active revolution rate sensor is connectable to the first connection and a brake lining wear sensor is connectable to the second connection, or a brake lining wear sensor is connectable to the first connection and a passive revolution rate sensor is connectable to the second connection.

18. The axle modulator as claimed in claim 17, wherein the first and second connections are provided for one side of the least one axle.

19. The axle modulator as claimed in claim 18, further comprising:
a third connection configured to connect to an active revolution rate sensor or a brake lining wear sensor; and
a fourth connection configured to connect to an passive revolution rate sensor or a brake lining wear sensor;
wherein the third and fourth connection are provided for another side of the least one axle.

20. The axle modulator as claimed in claim 19, comprising:
a first active revolution rate sensor connected to the first connection;
a second active revolution rate sensor connected to the third connection;
a first brake lining wear sensor connected to the second connection; and
a second brake lining wear sensor connected to the fourth connection;
wherein the active revolution rate sensors and brake lining wear sensors are connected simultaneously.

21. The axle modulator as claimed in claim 19, comprising:
a first brake lining wear sensor connected to the first connection;
a second brake lining wear sensor connected to the third connection;
a first passive revolution rate sensor connected to the second connection; and
a second passive revolution rate sensor connected to the fourth connection;
wherein the brake lining wear sensors and passive revolution rate sensors are connected simultaneously.

22. The axle modulator as claimed claim 17, wherein each of the first and second connections comprises two electrical conductors for connecting a sensor.

23. The axle modulator as claimed in claim 17, comprising a brake lining wear sensor connected to one of the first connection or the second connection.

24. The axle modulator as claimed in claim 23, comprising a revolution rate sensor connected to the other of the first connection or the second connection.

25. The axle modulator as claimed in claim 24, wherein the revolution rate sensor comprises an active revolution rate sensor connected to the first connection, the brake lining wear sensor is connected to the second connection, and the active revolution rate sensor and the brake lining wear sensor are connected simultaneously.

26. The axle modulator as claimed in claim 24, wherein the revolution rate sensor comprises a passive revolution rate sensor connected to the second connection, the brake lining wear sensor is connected to the first connection, and the passive revolution rate sensor and the brake lining wear sensor are connected simultaneously.

27. The axle modulator as claimed in claim 17, wherein the active and passive revolution rate sensors are connectable to one another.

28. The axle modulator as claimed in claim 17, comprising two passive revolution rate sensors and two brake lining wear sensors for two sides of the axle, wherein the comprising two passive revolution rate sensors and two brake lining wear sensors are connectable at the same time.

29. A regulating unit for an axle modular for regulation of brake cylinder pressure of at least one axle of a vehicle, the axle modulator being the axle modulator of claim 17.

30. A braking system comprising at least one brake control unit and at least one axle modulator in accordance with claim 17.

31. A vehicle comprising the braking system of claim 30.
